(19) United States
(12) Patent Application Publication
(10) Pub. No.: US 2019/0354912 A1
(43) Pub. Date: Nov. 21, 2019

(54) SYSTEM AND METHOD FOR SOFTWARE ADOPTION

(71) Applicant: APPLANGO SYSTEMS LTD., Rosh Ha'ayin (IL)

(72) Inventors: Samir VARMA, Cos Cob, CT (US); Daniel SARFATI, Raanana (IL)

(73) Assignee: APPLANGO SYSTEMS LTD., Rosh Ha'ayin (IL)

(21) Appl. No.: 16/349,769

(22) PCT Filed: Nov. 14, 2017
(86) PCT No.: PCT/US17/61641

§ 371 Date: May 14, 2019

Related U.S. Application Data
(60) Provisional application No. 62/421,924, filed on Nov. 14, 2016.

(51) Int. Cl. G06Q 10/06

(52) U.S. Cl. CPC G06Q 10/06375; G06Q 10/06393

(57) ABSTRACT

Systems and methods are described for determining one or more benchmarks for software usage of an organization based on data internal to the organization. In one example, usage data of a software application of an organization may be obtained or collected. One or more expected users of the software application may be identified. Next, at least one benchmark for usage of the software application may be determined based on a power law, the identified expected user or users, and usage data internal to the organization. The obtained usage data may then be compared to the one or more benchmarks, and results of the comparison output, for example via a graphical user interface or a report.

### COPYRIGHT NOTICE

This disclosure is protected under United States and/or International Copyright Laws. ©2016 Applango Systems, Ltd. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyright rights whatsoever.

### BACKGROUND

When an organization desires to launch an enterprise-wide software application, the challenge often lies in how to identify the proper software application to purchase, how to implement the chosen software application, and how to measure the usage activity of the software application. For example, an organization often buys licenses based on what the salesmen convince them to purchase, rather than buying licenses which the organization needs. Similarly, people leave and new people join the organization, so it can also be difficult to ensure there is the proper training in place so that people know “how, when, and why” they should use the software application. When trying to understand the value and effectiveness of the software application, the organization may send polls, but people will often lie on polls and/or respond with the answers they believe the organization wishes to see.

Moreover, even when there is data collected, it can be difficult to make any meaningful determinations. More usage does not necessarily reflect a more successful adoption as employees are not expected to spend 100% of their working time on any particular application. There is also no standard set for accepted levels of software usage, and external data points are not generally available for comparison.

### SUMMARY OF THE INVENTION

One of the metrics utilized to determine the success and effectiveness of a software application is to measure its adoption rate. The methodology disclosed in this application, in one aspect, creates an objective benchmark to measure the “health” of user software adoption of a software application within an organization. In another aspect, the benchmark may be utilized to identify abnormal software usage to direct positive change in a group of users of the software. In yet one aspect, the usage of software by a group may be analyzed to determine normal, sub-normal, and exceptional usage patterns to inform procedural changes for individual users within a group of users, or across an organization.

### BRIEF DESCRIPTION OF THE DRAWINGS

FIG. 1 illustrates an example flow diagram of a process for determining Overall Adoption Health Status and Usage Activity of a Company.

FIGS. 2A, 2B, 3A, 3B, 4A, 4B, and 4C illustrate an example graphical user interface displaying charts showing the Overall Adoption Health Status and Usage Activity of a Company.

FIG. 5 illustrates an example flow diagram of a process for analyzing and categorizing software usage within a group of users.

FIGS. 6A, 6B, 7A, 7B, and 8A-8D illustrate example analyzes of software usage.

### DETAILED DESCRIPTION OF THE PREFERRED EMBODIMENT

### Software Adoption

The concept of software adoption is easily tied to the number of people who have access to software. Tracking user logins is a basic indicator that provides clear and initial proof of usage, access, and/or activity. Software as a service applications (SaaS) as well as single sign-on applications (SSO) often provide reports on login activities.

For mission critical applications (i.e., those applications that are critical to the daily operations and success of the business/organization), however, proof of login is not enough to provide a good indicator of software adoption of usage. In addition to access, organizations need to understand in fine detail how the applications are being used. A complete list of every activity performed by every user, with its timestamp, can be obtained through log files and/or through probes installed on the software. This is known as usage data.

In order to measure the degree of software adoption via usage data, usage data should be compared to a benchmark or standard. For example, an optimal usage data pattern is likely one that is in line with management directives and expectations on which business operations/process should be performed on such applications and how the use of the software applications are intended to meet the business objectives. This involves a comparison based on expected usage, by activity and by user, at a very high level of detail. However, even the managers themselves may not be able to produce a detailed and quantifiable list of expected activities to be performed and by whom. Much of this information is outside the scope of the normal managerial attention level.

### Implied Comparison Values

The present disclosure addresses this problem by generating one or more implied comparison values for usage data via an algorithm, with or without knowing manager expectations.

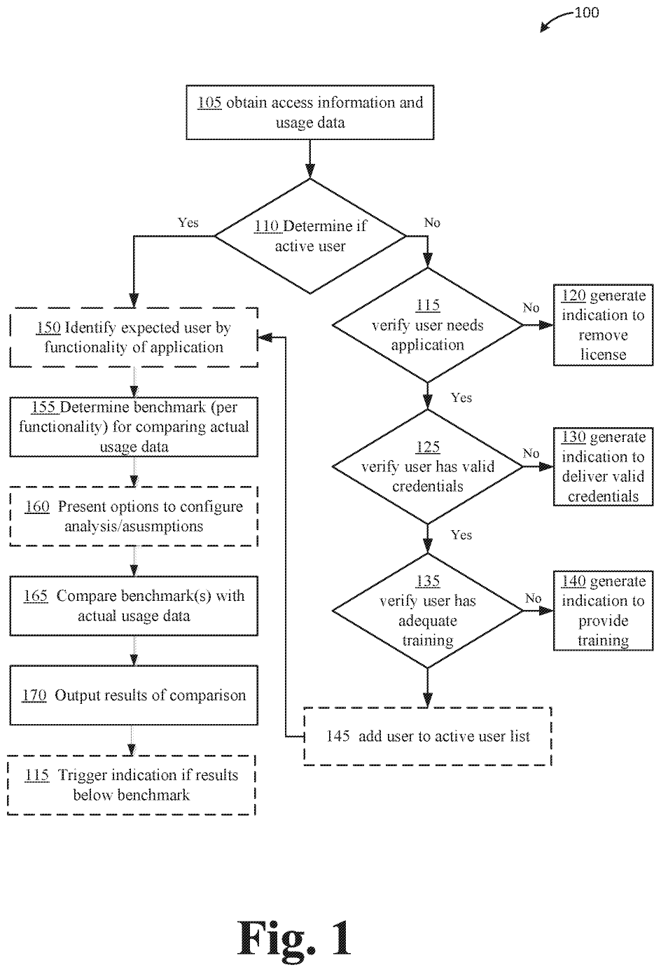

FIG. 1 illustrates an example process 100 for determining one or more usage benchmarks. It should be appreciated that operations indicated by dashed lines are optional. It should also be appreciated that in some implementations, one or more operations may be omitted from process 100. Process 100 begins with obtaining access or login information from or of a software system under analysis, at operation 105. Next, that information may be divided into two groups of users (those with access to a license): those with proof of login (“active users”) and those who have never logged in (“inactive users”), at operation 110. The reason for the divide is that if there is overall low-adoption of the software, there is a difference between low-adoption users who know how to login and users who never logged in, and thus should be categorized differently.

For the first group of active users, the objective is to identify why adoption is low and motivate users to interact more with the application. In the second group of inactive users, the objective becomes verifying that they need the application (operation 115), that they have valid credentials (operation 125), and that they are trained in using the application (operation 135). Various actions can be performed in response to a determination that any of need, credentials, or training is lacking (at operations 120, 130, 140). In the event that the inactive user needs the application, has valid credentials, and is properly trained to use the software, the user may then be added to the active user list (operation 145), or some other action may be taken.

Among active users, the question still remains: how to identify “low” adoption, or in other words, how to define “expected usage.” It is inherently difficult to ascertain which users should use the various functionalities of the application and the rate or frequency at which usage should happen, if at all.

The first part of “expected usage” is identifying the “expected user” of a particular functionality, at operation 150. If a user has touched a functionality, it is assumed that he/she is an expected user of that functionality.

The next issue is to determine what the expected pattern of activity is for an expected user, a given group of users, and/or for the whole company. Typically, the method of determining expected pattern of usage would be to create a benchmark by looking at the patterns of other, similar, organizations, and comparing one's own activity to that of others. However, in this case:
(1) No such data exists because the software vendors do not collect it. The data contemplated is very granular software usage data: every activity by every user on every object. It would entail collecting a record of every single activity on every single object by every single user on the application system. This is millions upon millions of pieces of data every week. For example, imagine that 5000 users update/create and delete an average of 100 objects per day. That's 500,000 activities per day that we have recorded, which is 5×500,000=2.5 million activities per week. Then, that data has to be analyzed in some way to produce useful business value. (2) There is no way of knowing which external organizations are relevant to benchmark against. Should the organizations be the same size, have the same number of licenses, same age of installation, revenue per employee, number of countries operated in, number of divisions, etc.?

As will be described in more detail below, one or more benchmarks may be determined at operation 155, for example, based on usage of an entire application, or one or more specific functionalities thereof. The one or more benchmarks may be determined directly from the collected data without need of or reference to data from another organization or application: in other words, a self-generating benchmark. Actual usage data may then be compared to the one or more of these self-generated benchmarks, at operation 160. In some cases, one or more options to configure or modify the analysis may be presented at operation 165, for example, to adjust the usage level used as a benchmark. The results may then be displayed or delivered at operation 170. In some cases, one or more indications may be triggered if the results fall below the one or more benchmarks, at operation 175. Ways in which to determine the one or more benchmarks, as performed at operation 155, will be described below.

In some cases, a benchmark may be determined at operation 155 for usage of an entire application, program, etc., and not be broken into functionality or object.

### Benchmarking

Benchmarking is common in business and its usefulness in contextualizing performance is widely accepted. As discussed, creating a benchmark usually requires data that is external to that which is being benchmarked. For many business functions, such external data is commonly available. Consider the following examples:

To benchmark how efficient your hospital is, you would collect data from many other hospitals and compare yourself to them.

The University of Chicago Law school is ranked #4 amongst all law schools in the United States. This is a benchmark, and the result is 4. The data is external to the University of Chicago—that is, you need data from ALL law schools in the US.

GE aero engines use 20% less floor space in its factory to produce jet engines than SNECMA and Rolls Royce. This is a benchmark, and the number is 20%. You need data external to GE (that is, you need data regarding the floor space of engines from the other aero engine manufacturers).

The profits per partner of Simpson Thatcher are $x per year and they are higher than all but y law firms in NY. This is a benchmark, the number is x, and the data is external to Simpson Thatcher (you need data from all NY law firms). And so on.

For software adoption, company-to-company comparisons are nearly impossible and/or worthless because the external data does not exist, because no one collects it, and thus there is no benchmark. And even if the data can be collected, the precise comparable organization to benchmark against may be extremely difficult or impossible to find.

### Fitted Distributions

To address this and other problems, a way of deriving an expected usage pattern (i.e., benchmark) from the data itself has been created. To determine acceptable versus un-acceptable usage levels, an extensive research project to identify a “minimal usage pattern” was conducted That is, a usage pattern such that if the group/user/company is not at least hitting that pattern, there is a good chance that the usage is unhealthy.

The described solution includes the manipulation of two mathematical theories and combines them in order to provide an answer to benchmarking using only internal data and, as a bonus, provide insights for positive organizational change.

### Gini Coefficient

One important aspect of determining an internal data-based benchmark is determining the level of “equality of usage” in the system. There is a well-known formula in economics called the “Gini Coefficient” (GC). The GC measures the extent of inequality in any distribution of outcomes. Most classically, the GC is a measure of statistical dispersion intended to represent the income distribution of a nation's residents, typically the inequality in wealth and in income.

A GC of zero (0) expresses perfect equality: everyone has the same level of the value that is being measuring. A GC of one (1) represents perfect inequality: for example, only one person has all the income or wealth and the others all have zero.

For the present solution, 1−GC is an excellent indicator of usage health: if there was zero inequality, then 1−GC=1−0=1=100%. This would mean everyone is using the application equally. While measuring usage equality was an objective, however, 100% as the benchmark is not a good indication of ideal or optimized usage. 100% as a benchmark would fail because it is completely impossible for every user interacting with the application to interact with it exactly the same amount. Furthermore, who's to say that this should be the target companies are striving for. Some people will naturally need to use the system more, and some less. So then, how can those individual users and/or groups of users that are not using the application properly be identified? What is the absolute minimum acceptable level of usage in an organization? Can that be defined? In order to address these questions, an index was defined as 1−GC of the data.

### Power Laws

Empirically, a wide variety of systems follow what is known as “power laws,” including man-made systems, biological systems, or even physical phenomena. All these systems tend to follow these power laws over a very large range of magnitudes. Take, for example, the sizes of earthquakes, the frequencies of word usage in most languages, the distribution of craters on the moon, the frequencies of family names, wealth, criminal charges per convict—all of these tend to follow power laws.

There are situations in which one can be reasonably certain that a particular statistical distribution is likely to apply to the data in question. For example, the size of cities in any country follows a power law. If you rank all the cities in the country, the largest by population is generally twice the size of the second largest which is twice the size of the third largest and so on. Similarly, in the English language, the most used word is used twice as often as the second most used which is used twice as often as the third most, and so on. This kind of relation is called a power law and it was first discovered in 1949 by the linguist George Zipf. (Zipf's law states that while only a few words are used very often, many or most are used rarely, Pₙ˜1/n^{a} where Pₙ is the frequency of a word ranked nth and the exponent a is almost 1. This means that the second item occurs approximately ½ as often as the first, and the third item ⅓ as often as the first, and so on. Although he originally intended it as a model for linguistics, Zipf later generalized his law to other disciplines. In particular, he observed that the rank vs. frequency distribution of individual incomes in a unified nation approximates this law.)

### Pareto Principle

One example of a power law that particularly occurs frequently in human-related phenomena is the Pareto principle (also known as the 80-20 rule, the law of the vital few, and the principle of factor sparsity). The Parteto principle states that, for many events, roughly 80% of the effects come from 20% of the causes. Mathematically, the 80-20 rule is roughly followed by a power law distribution for a particular set of parameters (here, known as a Pareto distribution).

In particular, the distribution of wealth follows a Pareto distribution (80% of the wealth in Italy was owned by 20% of the people), and the Italian economist that this principle is named after, Vilfredo Pareto, developed these concepts in the context of the distribution of income and wealth among the population. It is also a common rule of thumb in business: e.g., “80% of your sales come from 20% of your clients.” In software engineering, Lowell Arthur expressed a corollary principle: “20 percent of the code has 80 percent of the errors.” Many natural phenomena have been shown empirically to exhibit such a distribution: 80% of the peas in Vilfredo Pareto's garden were produced by 20% of the pods, and so on.

There are many kinds of systems in which power laws apply: these tend to be complex systems with a large number of interacting parts. One such system is certainly software usage. It fits the definition of a complex system. It is a system with many interacting parts: e.g., the number and type of users, the number and types of licenses, the setup of the objects accessed by the users, the business processes, the amount of data entered by the users, the management methods and styles of the company or organization, etc. Every one of these interacting parts affects the usage patterns of the software application. As such, it can be assumed that power laws hold true for software usage. Based on this realization, a Pareto level usage (that is, 80% of application usage is performed by 20% of the people) can then be used as a bare minimum acceptable usage pattern. In a preferred embodiment, the bare minimum acceptable level of usage is defined as such.

### Preferred Embodiment

Based on the Pareto principle, usage of any object, or usage by any group or user or organization, should have 80% of the activities done by at least 20% of the people. If 80% of the activity is done by less than 20% of the people, it indicates a likely problem. This should be an “easy” benchmark to meet. Surprisingly, many organizations struggle to meet even this easy benchmark with their software application deployments.

To make the data easy to interpret, an index was defined that converts the usage pattern to an easy to understand number. A usage pattern of 80%/20% (that is, 80% of the activity is done by 20% of the users) corresponds to an index of 40. A usage pattern of 70%/30% (that is, 70% of the activity is done by 30% of the users) corresponds to an index of 60. The higher the better. An index of less than 40 indicates a likely usage problem and the lower it goes the more severe the problem. An index above 60 usually indicates good, healthy, usage.

It is then possible to benchmark how much better or worse software usage is when compared to the 80/20 benchmark. And, to do that, 1−GC does the trick. When 1−GC=0.4, it means that usage pattern is 80/20. At 1−GC=0.6, usage is now 70/30 (i.e., 70% of the work is done by 30% of the users). This means that 1−GC can serve as an indication of “quality of usage:” a minimum acceptable level of 0.4 (which occurs at 80/20) with a target of trying to reach or exceed 0.6 (which occurs at 70/30).

In one example, different values for the Gini Coefficient correspond to different levels of inequality (i.e., different levels of the Pareto statement. One implementation of an index includes modifying the GC value as follows: (1−GC)*100. This implementation changes the representation such that perfect equality equals 100 rather than 0 so as to be a more readily understandable indication of equality rather than inequality. For ease of interpretation, one wants to know what Pareto values correspond to what Gini values.

One skilled in the art would understand that there are many different ways of calculating the GC, and there are many different definitions for different purposes. One example is provided below.

The Gini coefficient (or Gini ratio) G is a summary statistic of the Lorenz curve and a measure of inequality in a population. The Gini coefficient is most easily calculated from unordered size data as the “relative mean difference,” i.e., the mean of the difference between every possible pair of individuals, divided by the mean size μ,

$$G = \frac{\text{?} \text{?} \vert {x}_{i} - {x}_{j} \vert}{2 {n}^{2} μ}$$

$$\text{?} \text{indicates text missing or illegible when filed}$$

(Dixon et al. 1987, Damgaard and Weiner 2000). Alternatively, if the data is ordered by increasing size of individuals, G is given by:

$$G = \frac{\text{?} ( 2 \text{?} - n - 1 ) \text{?}}{{n}^{2} μ}$$

$$\text{?} \text{indicates text missing or illegible when filed}$$

(Dixon et al. 1988, Damgaard and Weiner 2000), correcting the typographical error in the denominator given in the original paper (Dixon et al. 1987).

The Gini coefficient ranges from a minimum value of zero, when all individuals are equal, to a theoretical maximum of one in an infinite population in which every individual except one has a size of zero. It has been shown that the sample Gini coefficients defined above need to be multiplied by n/(n−1) in order to become unbiased estimators for the population coefficients.

The Gini coefficient for the Pareto distribution is then calculated for (for α≥1)

$$G = 1 - 2 ( {\int }_{0}^{1} L ( F ) dF ) = \frac{1}{2 α - 1}$$

(see Aaberge 2005). According to the above formula, 80/20 corresponds to 0.6, so (1−GC)*100)=40, and 70/30 corresponds to 0.4 so (1−GC)*100=60).

### Benchmarking Software Application User Adoption

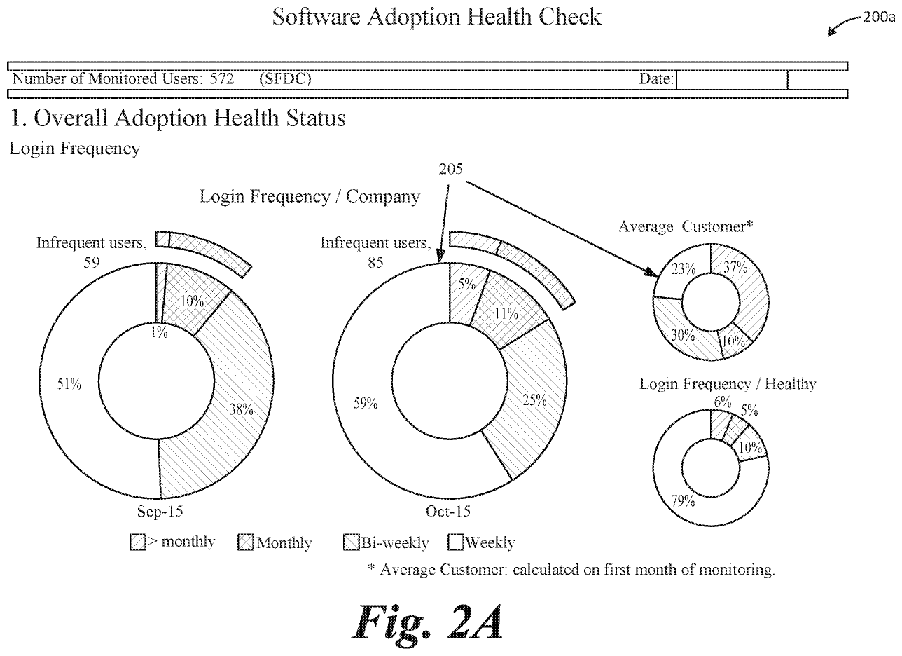

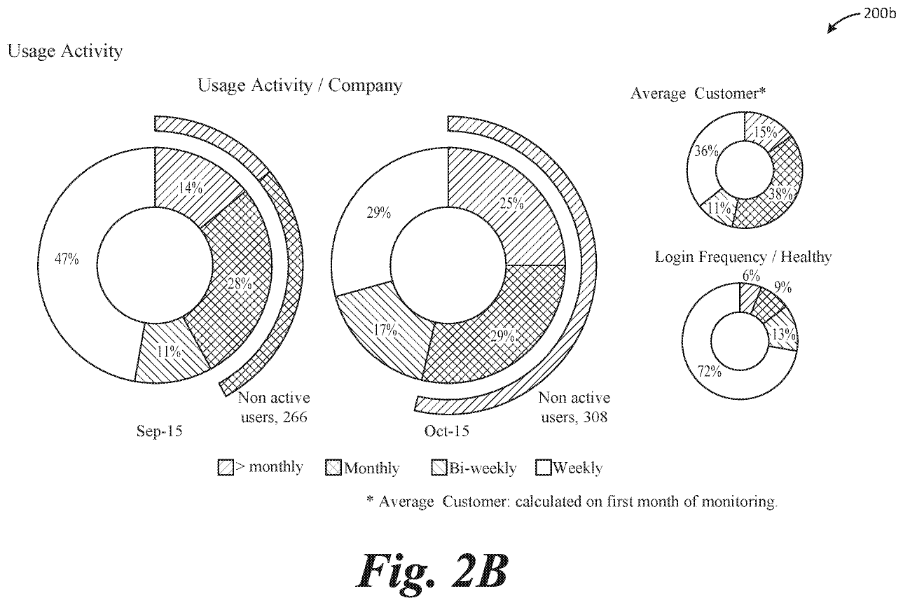

A lack of measurement leads to a lack of management. One cannot manage what one is not measuring. According to the described systems and methods, a report that collates indexes for all aspects of usage can be generated in one document or view, screen, etc., to enable easily identification of problem areas. FIGS. 2A, 2B, 3A, 3B, 4A, 4B, and 4C illustrate example reports generated by an analytic tool or software application utilizing the processes described above. This type of analysis enables benchmarking various functionalities of software deployment and identifying the areas that have most need for improvement. In one aspect, an interactive graphical user interface is provided that enables easy viewing and manipulation of login information, usage information, and/or adoption information utilizing the benchmarking techniques described above. It should be appreciated that the information illustrated and described in reference to FIGS. 2-4 can also be generated in a static report for example.

FIGS. 2A and 2B illustrate example login and usage information of a software application provided in a graphical user interface 200 (which includes displays or screens 200a and 200b). By displaying the login and usage information, comparison of certain portions of the data may be performed more effectively and efficiently, such that certain characteristics between the data may be made immediately apparent to a user of the system. For example, comparing login frequency (e.g., representative of customer adoption) of a given software application, and an average of other usage, such as compiled by the system (e.g., within the system or organization), may be clearly illustrated at 205. Interface 200 may provide login information and usage activity in easily understandable graphs, charts, etc., such as illustrated and in other forms.

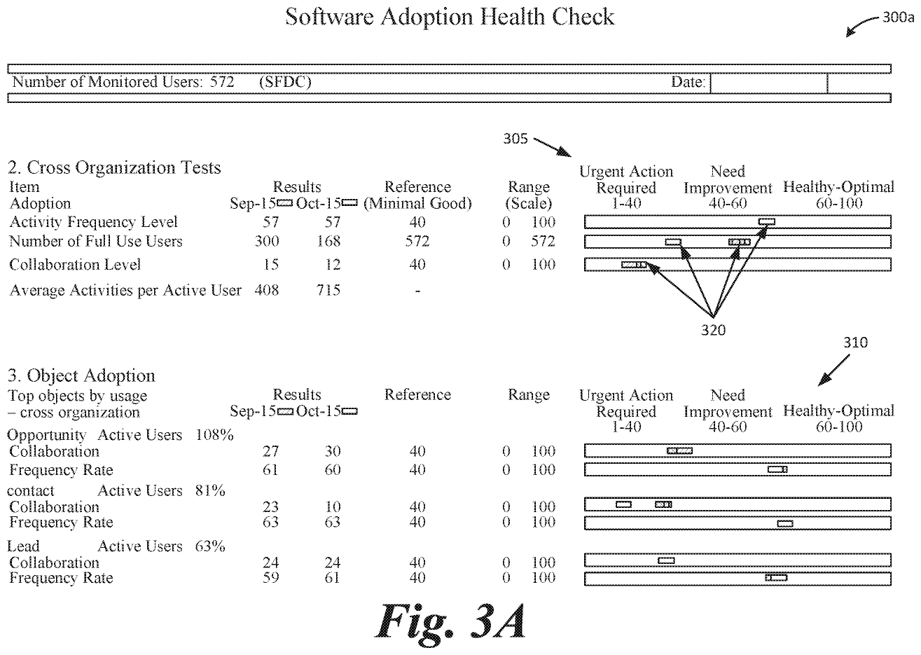

FIGS. 3A and 3B illustrate example analytics of usage of a software application provided in a graphical user interface 300 (which includes displays or screens 300a and 300b). Using the benchmark information, determined via the techniques described above, a scale can be developed, used, and displayed at 305, 310, and 315 based on data internal to an organization itself (e.g., not requiring external data to make the comparison against), to identify different levels of software adoption. The scale or distribution may include multiple ranges of values that each correspond to, for example, sub-adequate, adequate, and above-adequate software usage. The scale may be used to evaluate cross-organizational tests, object adoption (e.g., different features, functionality, options, etc., provided by the software), and group metrics (e.g., adoption by different groups within organization analyzing software adoption). Each individual item (row) may be evaluated separately, with a score illustrated in scale or chart 305, 310, 315, at 320. As illustrated, Frequency Rate (FR) indicates the distribution of activities throughout the working days in a given month. A FR=0 means all activities by a user are done on a single day in that month. A FR=100 means activities are evenly distributed through the month. The described system may calculate Frequency Rates for groups or objects, as well as for the whole organization. A Pareto distribution, where 20% of the users do 80% of the activities, produces FR=40. Collaboration Rate (CR) indicates the distribution of activities among the users of a given group. A CR=0 means all activities in a group are done by a single user, a CR=100 means activities are evenly distributed among all the users in a group. A Pareto distribution, where 20% of the users do 80% of the activities, produces CR=40

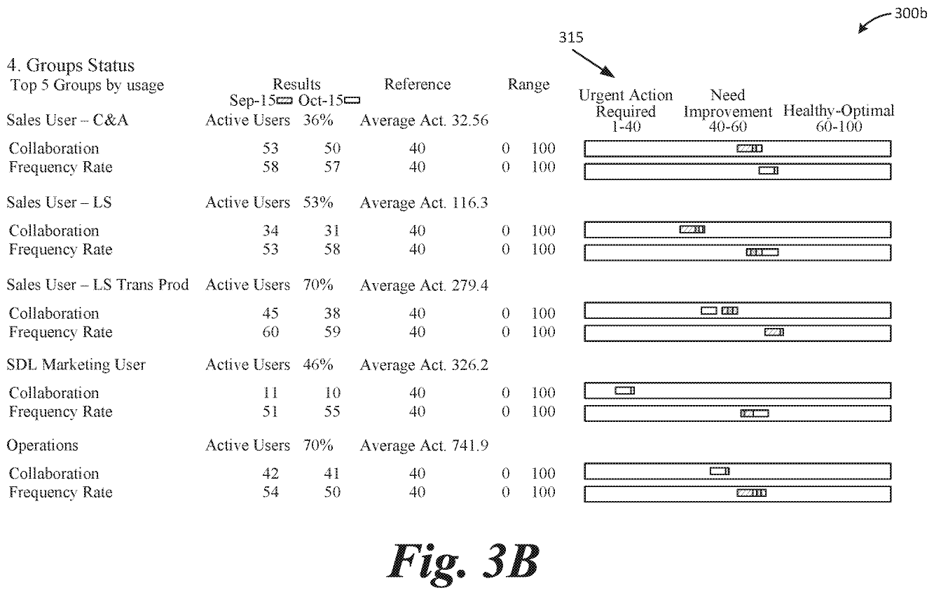

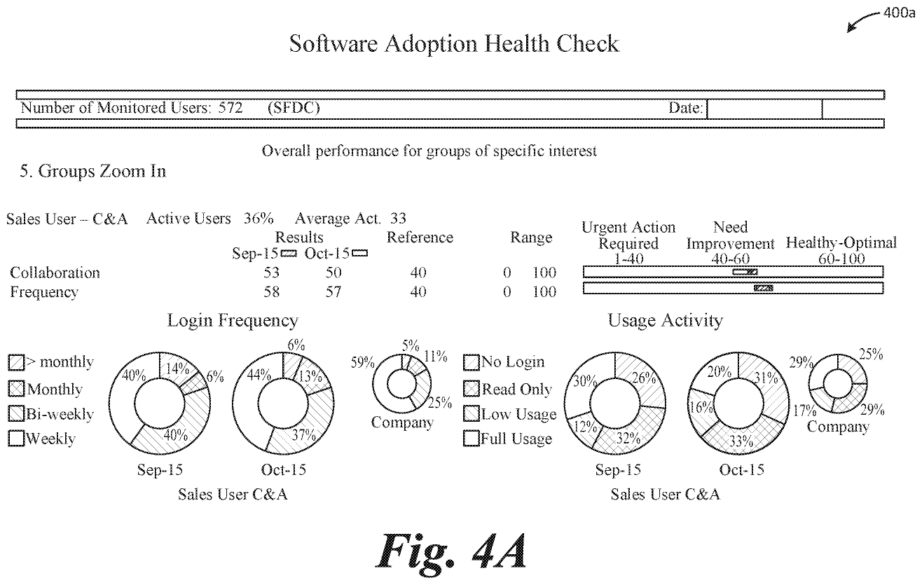

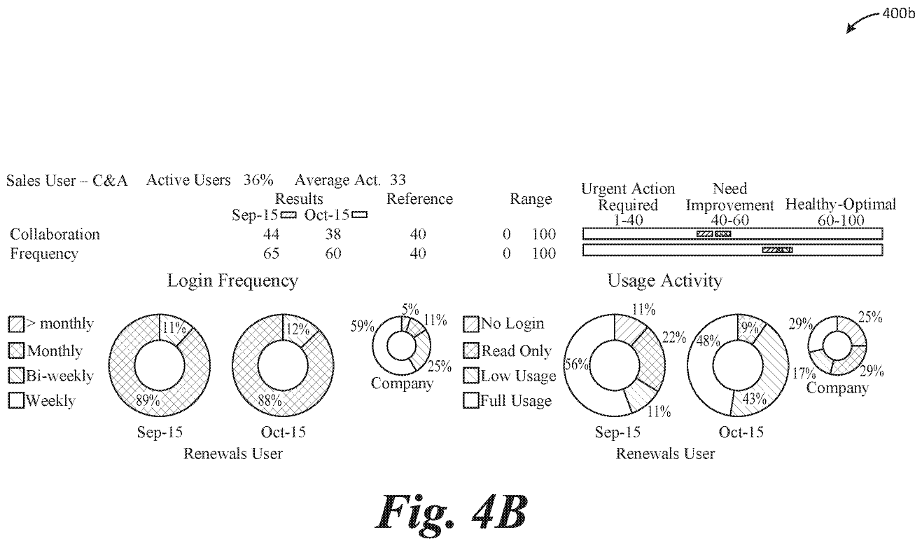

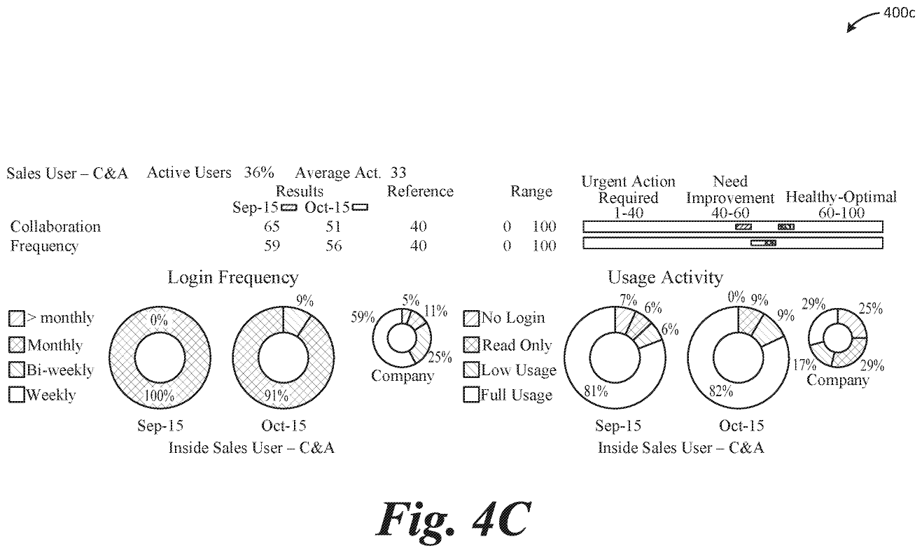

FIGS. 4A-4C illustrate an expanded view of group adoption and usage information, as illustrated in FIG. 3B, via graphical user interface 400 (which includes displays or screens 400a, 400b, and 400c). As illustrated in interface 400, login and usage information may be readily displayed month by month, in a way the effectively enables comparison of the data to identify trends or patterns.

The above interfaces help to illustrate the usefulness of benchmarking software usage and adoption in an organization according to the described techniques. The graphical user interfaces/reports described above are only given by way of example. Other arrangements of certain data, and other graphical elements employed to convey the information, for example, are contemplated herein.

The described systems and methods are founded on an innovative recognition that this particular combination of relationships (the Gini coefficient and the Pareto principle) produces a general purpose result, for all usage/activity/other power law metrics in complex systems (not just software adoption, but any such power law style measurement).

### Using Benchmarking to Optimize Software Usage and Increase Performance

In some aspects, after determining software usage as compared to the determined benchmark or benchmarks, the analysis can be taken one step further. For example, usage may then be compared among users of the group to analyze behaviors, to ultimately effect positive change in practice and procedure of an organization. In one example, the usage of a certain individual or group in a particular role may be dissected and analyzed. The usage may then be correlated with some performance metric or metrics (e.g., customer satisfaction, resolution of tickets, etc.). This information can then be provided to inform decisions concerning changing practices of the group, asking specific users to change their respective practices, etc.

The difference in adoption reflects, and often points to, differences in behavior. For instance, it is possible to differentiate between two users in the same micro-group (e.g. they are supposed to behave similarly) according to their frequency of usage of a certain functionality, such as the number of case openings, or the number of updates to a certain customer case. This has a direct effect on the efficiency of each of the agents for each specific case handled, but over time also provides interesting trends relative to the capabilities of each individual to yield behavior patterns.

This information, specifically because it can be generated internally, without access to information from or concerning other organizations, provides valuable information and insight into improving practices and performance of users of specific software applications, increasing efficiency, profits in business, etc.

In some cases, the techniques described herein can help boost employee productivity and performance by using artificial intelligence (AI) or machine learning, to find best practices in an organization for every single activity and every single group of people. The described techniques can provide effective tools for employee self-improvement and morale. The described techniques can be used to find hidden patterns that will increase sales, customer satisfaction and retention and ultimately repeat business wins for companies. The described techniques can also be used to improve data quality and adoption, and to implement best practices on the Salesforce platform or other similar platforms. The described techniques can be used to promote excellence and accountability in the enterprise, find measurable best practices at the micro level, and show/teach every user how to reach professional excellence. Some users may show patterns that are at odds with good adoption. The described techniques may be used to find unusual and extreme behaviors that are recurrent across all verticals. “Good” behaviors may be taught and become best practices while “bad” behaviors are contained or eliminated. In some cases, usage data may be continuously crowdsourced from each organization's activities in fine detail. AI or machine learning may be applied to activities measured on objects by users producing behavioral patterns. In some cases, all users for all activity using all objects may be compiled. Behaviors may then be detected using neural network classifiers. User attributes (e.g. profile, manager, role) can be used to contextualize behaviors and produce actionable outputs.

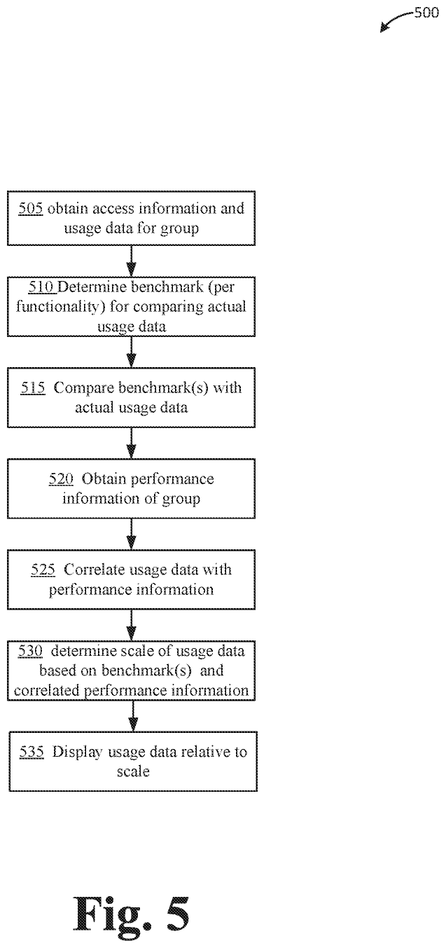

FIG. 5 illustrates an example process 500 for analyzing software usage of a group of users to determine one or more practices for improvement, either on a group level or individual level. In some cases, one or more operations of process 500 may be combined with process 100 described above. For example, in one aspect, one or more of operations 105, 150, 155, 160, 165, 170, and/or 175 may be preplaced or combined with one or more operations 505-530 of process 500 to yield one process. As described below, any reference to process 500 also refers to any combination or process 100 and 500, or process 100 alone.

Process 500 may begin at operation 505, where usage information for a given software program may be obtained, for example by and within an organization. Net, one or more benchmarks may be determined at operation 510. In some cases, login information may first be obtained, and users divided in active and inactive users (e.g., see operation 110 of process 100), in order to focus the results of process 500. At operation 515, the benchmark data may be compared to actual usage data. In some cases, performance information of the group may be obtained at operation 520. Performance data may include sales closed by an associate, call request completion by a call center representative, and so on, for a group of users. Next, the performance information may be correlated with the usage data, at operation 525. Operation 525 may include correlating certain software usage patterns with adequate or satisfactory performance data, sub-adequate, or even excellent performance data. In some aspects, correlating may be performed via AI, machine learning, neural networks, or a combination thereof. Next, at operation 530, a scale or range of software usage may be determined or generated based on the one or more benchmarks and the correlated performance data. The scale may indicate different levels or categories of usage, for example, normal or satisfactory, sub-satisfactory, and excellent or above-satisfactory. Various examples of different information and different ways to display the information generated via processes 100 and/or 500 are described below.

For example, FIGS. 6A and 6B represent usage information, and patterns gained therefrom, relating to lead development by sales representatives or reps. In a sales environment, organization, etc., for example, sales rep may be expected to enter new leads as they happen. Using process 500, reporting information may be analyzed concerning how often representative update leads. In an example, it was found that some reps updated their leads only once a month while the rest were updating as they collected them. By analyzing the frequency of lead collection, it may be determined what is normal for a specific group of sales reps and what is somehow different from such normality. Among such reps there are some that will enter their leads very seldom compared to the group. This is represented in FIG. 6A where each rectangle corresponds to a sales rep. The surface of the rectangle is proportional to the number of leads in the period under scrutiny (the more the leads the larger the rectangle) and the color (shading) represents the frequency (green=very frequent and red=very seldom), according to the key provided in FIG. 6A. Frequency is sorted from most frequent to least frequent and each rep is assigned a color and a quantity of leads.

FIG. 6B shows why a rep was characterized as having sub-normal reporting practices. This rep has produced 1,432 leads on one day and only a few leads on a few days during the month. As a comparison, his/her colleagues are producing a few tens of leads every work day. Software utilizing process 500 may flag reps with such unusual behavior as they are not reporting on their leads with sufficient timeliness. In one instance, correcting this behavior was found to improve the lead management process, the sales performance of the organization and even customer satisfaction. As a result, by determining abnormal behavior of software in a certain circumstances, and correlating that with, in some cases, external evidence or information, performance of an organization may be improved. In some cases, certain reps may manipulate reports to influence sales quotas. This type of behavior may be correlated with reps logging leads at certain (e.g., recurring) dates, reps having long “silent periods” and short bursts of a high volume of activities, or specific periodic behaviors such as right before or after the end of a quarter or in anticipation of a management review. In some cases, time and quantity may be specific to an organization, such that individualized data and special rules for interpreting that data are most effective. This behavior has been found to be organization-specific, leaving little or no room for external benchmarking, but making the self-reference benchmarking very valuable.

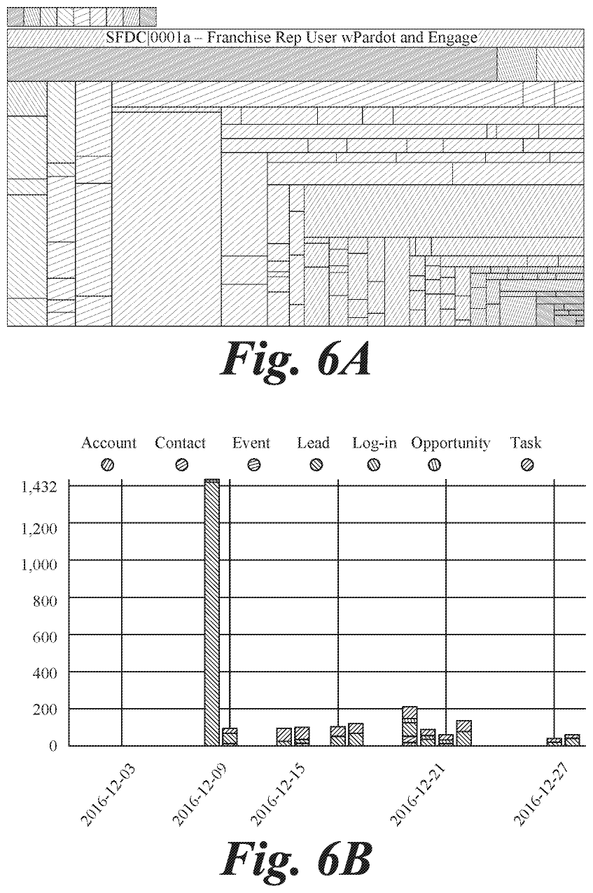

In another example, as illustrated in FIGS. 7A and 7B, process 500 may be utilized in a call center scenario to increase performance, e.g., through increases in efficiency, of call resolutions. Most call center agents can solve cases assigned to them. Some have a surprisingly high ratio of handovers (escalation) to their colleagues, a bad habit that increases costs to the contact center and reduce customer satisfaction. In this example, process 500 may be used to analyze the history of Cases as recorded on Salesforce CRM and isolate agents with abnormal handover levels. The heat map illustrated in FIG. 7A shows agents' handover ratio over a certain period where each rectangle corresponds to an agent. The surface of the rectangle is proportional to the number of cases handled in the period under scrutiny (the more the cases the larger the rectangle) and the color (shading) represents the handover ratio (green=very low and red=very high), per the key illustrated in FIG. 7A. Handover ratio is sorted from higher to lower and each agent is assigned a color and a quantity of cases as measured by the system.

FIG. 7B illustrates why an agent was associated with sub-normal call resolution performance. Process 500 may be used to flag reps with such unusual behavior as they are causing longer resolution time and frustration among the call center customers. Correcting this behavior may improve the case management process and the performance of the organization. In some cases, assessing different behaviors may include determining behaviors among multiple call center locations, and level of skill, and analyzing type and/or characteristics by case. This behavior has been found to be organization-specific, leaving little or no room for external benchmarking, but making the self-reference benchmarking very valuable.

In some cases, process 500 may be used to predict certain behavior within an organization, based on correlation between performance data and software usage data.

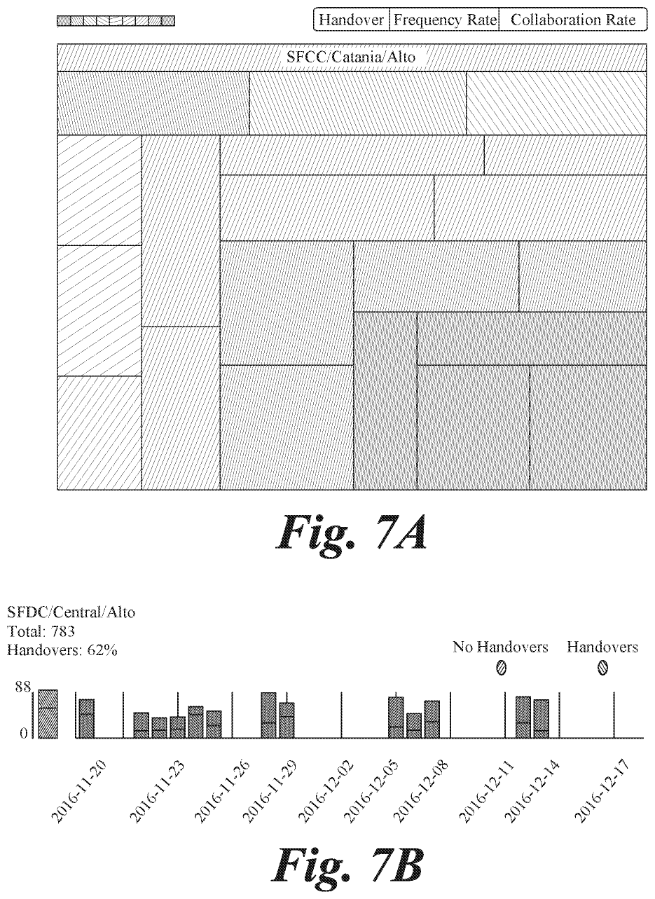

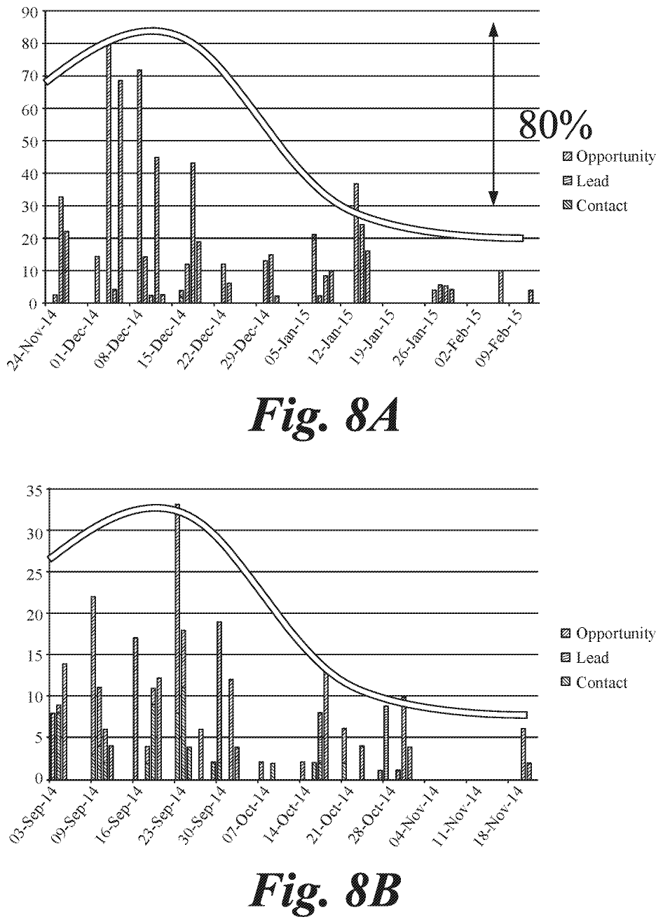

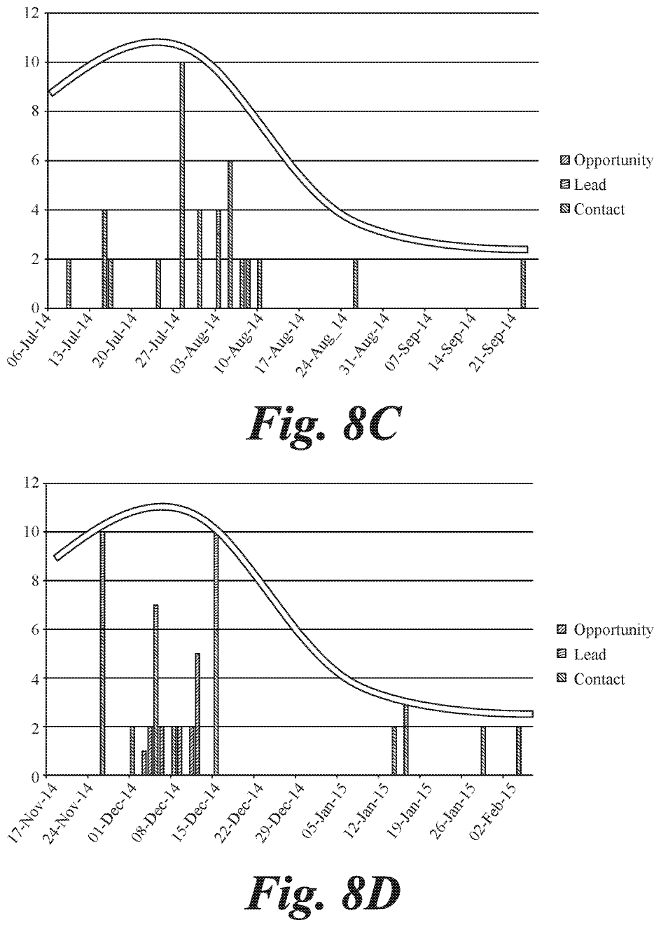

FIGS. 8A-8D illustrate software usage as correlated to attrition in an organization. Process 500 may be utilized to determine the relationship between usage and attrition, as illustrated in FIGS. 8A-8D, and be further used to predict when employees of a company will leave. The analysis of software usage among computer educated employees can be used to predict critical behaviors such as employees who are planning to leave the company. Users who plan to resign usually reduce their efforts while using such reporting tools as Salesforce. In the example illustrated in FIGS. 8A-8D, users who resigned show an 80% drop in Salesforce activity in the last two weeks of employment if compared to the average of the previous 90 days. This pattern recurs for over 65% of the users who left.

By analyzing correlations between software usage and employee actions, such as leaving a job, valuable insight may be gained to address issues before they reach a tipping point. This may include salvaging the employee relationship to prevent him or her from leaving, acting to protect the company's data, etc. In some cases, the indicators of such action may include a sudden reduction in quantity and quality of logged data in a software application, or a recognizable shaped pattern of usage, as illustrated in FIGS. 8A-8D. In some cases, certain patterns may be false positives, such as vacation, or company dependent behaviors that may be normal for that company. In some cases, these types of behaviors or patterns may be accounted for in assessing correlations and sub-optimal performance or performance indicative of certain actions. In some cases, specifically contact activities may be shown to increase on an employee's last week of work. This information may also be used to verify or increase the confidence in a prediction that an employee is about to leave the company. This behavior has been found to be organization-specific, leaving little or no room for external benchmarking, but making the self-reference benchmarking very valuable.

Each of the processes, methods and algorithms described in the preceding sections may be embodied in, and fully or partially automated by, code modules executed by one or more computers or computer processors. The code and results of the processes may be stored on any type of non-transitory computer-readable medium or computer storage device.

The various features and processes described above may be used independently of one another, or may be combined in various ways. All possible combinations and subcombinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

In some aspects, some or all of the systems and/or techniques may be implemented in software, firmware, hardware, or a combination thereof, such as one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the systems and processes may also be stored (e.g., as software instructions or structured data) on a computer-readable medium, such as a hard disk, a memory, a network or a portable device. The described techniques may be practiced using various computer hardware and configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only and are not intended to limit the scope of this disclosure. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope of this disclosure.

What is claimed is:

1. A non-transitory computer-readable medium on which are stored instructions that, when executed by at least one processing device, enables the at least one processing device to perform the operations of:
obtaining usage data of a software application of an organization;
identifying at least one expected user of the software application;
determining at least one benchmark for usage of the software application based on a power law and the at least one expected user, wherein the determining is based on the usage data only internal to the organization;
comparing the obtained usage data with the at least one benchmark; and
outputting results of the comparison.

2. The non-transitory computer-readable medium of claim 1, wherein the software application comprises at least two objects;
wherein the instructions for identifying the at least one expected user of the software application further comprise identifying the at least one expected user of the software application for each of the at least two objects;
wherein the instruction for determining the at least one benchmark, further comprise determining the at least one benchmark for each of the at least two objects; and
wherein comparing the obtained usage data with the at least one benchmark is performed for each of the at least two objects.

3. The non-transitory computer-readable medium of claim 1, wherein the instructions, when executed by at least one processing device, enables the at least one processing device to perform the operations of:
obtaining login information of users of the software application; and wherein the instructions for identifying the at least one expected user of the software application further comprise instructions for identifying only users that have logged into the software application based on the obtained login information.

4. The non-transitory computer-readable medium of claim 1, wherein the instructions, when executed by at least one processing device, enables the at least one processing device to perform the operations of:
obtaining performance information of users of the software application;
correlating the usage data with the performance information; and
outputting the results of the correlation.

5. The non-transitory computer-readable medium of claim 4, wherein the instructions, when executed by at least one processing device, enables the at least one processing device to perform the operations of:
determining a scale of usage based on the at least one benchmark and the results of the correlating the usage data with the performance information; wherein outputting the results of the correlating further comprises outputting the results of the correlating relative to the scale.

6. A non-transitory computer-readable medium on which are stored instructions that, when executed by at least one processing device, enables the at least one processing device to perform the operations of:
collecting customer usage data;
fitting the customer usage data over a distribution;
comparing the customer usage data against the distribution; and
determining, based on the data, at least one business value from the comparison.

7. The non-transitory computer-readable medium of claim 6, wherein the distribution comprises a Pareto distribution.

8. A non-transitory computer-readable medium on which are stored instructions that, when executed by at least one processing device, enables the at least one processing device to perform the operations of:
collecting customer activity data;
creating a distribution;
modifying the distribution based on one or more assumptions based on the customer activity data;
fitting the modified distribution to the customer activity data; and
determining, based on the fitted distribution, at least one business value.

9. At least one computer-readable medium on which are stored instructions that, when executed by at least one processing device, enables the at least one processing device to perform the operations of:
collecting data characterizing usage of a plurality of software applications hosted on a network by users of a set of at least one client device;
storing the collected data, wherein the collected data forms a collected data distribution;
comparing the collected data distribution with an assumed distribution;
determining, based on the comparison, at least one business value for at least one of the plurality of software applications.

10. The non-transitory computer-readable medium of claim 9, wherein the determining is based upon utilizing an index of 1−Gini Coefficient.
